(19) United States
(12) Patent Application Publication
(10) Pub. No.: US 2005/0203919 A1
(43) Pub. Date: Sep. 15, 2005

(54) Method and apparatus for reordering an arbitrary order signal sequence into a streamable signal sequence

(76) Inventors: L. Peter Deutsch, Menlo Park, CA (US); Raphael L. Levien, Benicia, CA (US); Raymond J. Johnston, Cypress, CA (US)

Correspondence Address: ALLAN J. JACOBSON, 13310 Summit Square Center, Route 413 & Doublewoods Road, Langhorne, PA, 19047, US

(21) Appl. No.: 10/796,774

(22) Filed: Mar. 9, 2004

(51) Int. Cl. G06F 7/00

(52) U.S. Cl. 707/100

(57) ABSTRACT

A data optimization method transforms an input Data File containing an Arbitrary Order Signal Sequence into a Streamable Signal Sequence having the same or compatible format as the original input Data File. The Streamable Signal Sequence, which represents the same information as contained in the original Arbitrary Order Signal Sequence, can be sequentially processed using less memory. In one embodiment, a Data File containing a PDF (portable document format) file, i.e., an Arbitrary Order Signal Sequence document is transformed from an arbitrary order organization into a Streamable Signal Sequence organization, more suitable for printing. Reordering an Arbitrary Order Signal Sequence into a Streamable Signal Sequence reduces the memory required to print a document as compared to the same document represented by an Arbitrary Order Signal Sequence.

### FIELD OF INVENTION

The present invention relates to the field of data optimization, and more particularly, the present invention relates to optimizing an Original Input Signal Sequence suitable for processing in an arbitrary order by transforming the Original Input Signal Sequence into a Second (Output) Signal Sequence optimized for sequential processing obtaining the same result as the Original Input Signal Sequence, but using less memory than would be required to process the Original Input Signal Sequence.

### BACKGROUND OF THE INVENTION

Portable Document Format (PDF) is a widely used page description language. A technical specification of the PDF format may be found in Bienz, Tim, and Cohn, Richard, PDF reference—third edition: Adobe Portable Document Format version 1.4 (ISBN 0-201-75839-3), published by Addison-Wesley, New York, N.Y.

A PDF Data File can be used to represent the features of any document, regardless of the type of document or the program source that created it. By using a universally accepted format (e.g., PDF), a document containing photographs, text, graphics or the like may be exchanged from a first user to a second user without requiring that the second user have access to the program source by which the first user created the document. Moreover, PDF documents are often more compact than the original document format, facilitating transmission efficiency and storage efficiency.

However, to print a PDF document, the PDF document must be translated into a printer compatible format such as PostScript or PCL (Printer Control Language). In general, PDF documents require a utility program, compatible with each particular model of printer, to print PDF documents.

A PDF Data File is a Structured Signal Sequence that is an Arbitrary Order Signal Sequence. That is, any portion of a PDF Data File may contain a reference to any other portion of the PDF Data File. Arbitrary Order Signal Sequences do not make good print files. A printer usually receives data and commands over a connection that is primarily sequential such as a serial, parallel or USB connection. A printer generally needs data in the same order as the document to be printed. For example, in printing a multi-page document, a printer generally needs page content data for the first page before it needs page content data for the second page, and so on, generally requiring data in the same order as the pages of the document. Furthermore, printers typically have limited storage capacity so identification of information that is only required on a specific page or range of pages may be critical to allow the storage to be used for processing subsequent pages.

To the extent that a printer has internal memory, high-level printer commands are typically stored in the printer memory and processed locally in the printer.

### SUMMARY OF THE INVENTION

It would be desirable to have a printer accept a PDF document directly, eliminating the need for a print utility program. However, the PDF document format is arbitrary access. That is, any portion of a PDF Data File could be needed on any portion of the document. Direct printing of totally arbitrary order PDF Data Files would require a printer to have sufficient memory to store the entire PDF Data File before it began printing the first page. Since the size of the PDF Data File could be very large (e.g., a 100,000 page document), direct printing of such large PDF Data Files would require a printer to have a very large memory.

The present invention is a method and apparatus for optimizing an Arbitrary Order Signal Sequence for sequential processing. In particular, the present invention is embodied in a method and apparatus for transforming an Arbitrary Order Signal Sequence into a Streamable Signal Sequence, wherein the latter Second Signal Sequence is better suited for sequential processing as compared to the Original Input Signal Sequence. In the case of PDF, streamable PDF Data Files are better suited for direct printing as compared to arbitrary order PDF Data Files. In particular, a printer requires less memory to print a document represented by a streamable PDF Data File as compared to the memory required to print a document represented by an arbitrary order PDF Data File.

Two embodiments are disclosed: a general case relevant to any Arbitrary Order Signal Sequence, and a specific case applicable to arbitrary order PDF files.

### DEFINITION OF TERMS

Arbitrary Order Signal Sequence or Original Input Signal Sequence or Input Signal Sequence: A Sequence of Signals in which Object Signals appear in an arbitrary order.

Atomic Data Element: A fixed sized unit of information.

Data File: A Signal Sequence stored on a memory device such as disk drive or other storage device including RAM, ROM, CD-ROM or other memory/storage devices. The storage device may be of a type that allows for efficient random access to any part of the Data File, or may be of a type that preferentially supports sequential access to the Data File.

Input Signal Sequence: See Arbitrary Order Signal Sequence or Original Input Signal Sequence

Identifier Type Object Reference or Object Identifier: Where a Signal includes an Object Reference in the form of a unique identification code (Object Identifier). Object Identifiers must be unique so that the references are not ambiguous. Identifier Type Object References may be correlated to Position Type Object References in the Sequence by cross-reference tables that map Object Identifiers to Object positions.

Object: A unit of a program containing instructions and/or data.

Object Identifier: See Identifier Type Object Reference

Object Signal: A Signal containing an Object. Object Signals may also include Object References to other Object Signals in the form of their identifier or position in the Signal Sequence.

Object Splitting: An Object may be split into multiple Objects such that each Object Reference from the Object to a Successor Object is at the end of the multiple Objects thus created. This facilitates a refinement of the invention.

Object Reference: A portion of an Object Signal identifying (i.e., referencing) another Object Signal in the Signal Sequence.

Object Replication: A Shared Object that only occurs once in the Input Signal Sequence may be copied to create another unique Object that can be placed into the Streamable Signal Sequence to facilitate a refinement of the invention. While the replicated Object will have a unique identifier, the information within the Object will be the same as the contents of the original Shared Object.

Original Input Signal Sequence: See Arbitrary Order Signal Sequence or Input Signal Sequence

Output Signal Sequence: See Streamable Signal Sequence or Second Signal Sequence:

Position Type Object Reference: Where a Signal contains an Object Reference referring to another Object in the Sequence by its position in the Sequence.

Predecessor Object or Referencing Object: An Object Signal that contains an Object Reference to another Object Signal. The Predecessor Object containing the Object Reference is said to be the “predecessor” to the Object that is referenced. An Object may have more than one Object that is a Predecessor Object since several Objects may a reference to another Object.

Referenced Object: See Successor Object

Referencing Object: See Predecessor Object

Shared Object or Shared Referenced Object: An Object Signal that has more than one Object Reference from another Object to such Shared Object

Signal: A block of information formed by an integral number of Atomic Data Elements. Various types of Signals.

Signal Sequence or Sequence of Signals or Sequence: A transmitted group of Signals appearing in an adjacent contiguous order.

Streamable Data File or Sequential Data File: A Data File constructed so as to allow for efficient processing when the storage device does not support random access.

Streamable Signal Sequence or Output Signal Sequence or Second Signal Sequence: A Sequence of Signals optimized for sequential processing. In accordance with the present invention, an Original Input Signal Sequence is transformed into a Second Signal Sequence optimized for sequential processing. In other words, an Arbitrary Order Signal Sequence is reordered into a Streamable Signal Sequence.

Structured Signal Sequence: An Arbitrary Order Signal Sequence or a Streamable Signal Sequence containing a plurality of Object Signals and Object References.

Successor Object or Referenced Object: An Object Signal that is referenced by an Object Reference from another Object Signal. The Successor Object so referenced is said to be a “successor” of the Object that contains the Object Reference. A Successor Object may be the successor of several Objects since many Objects may reference the same Successor Object.

Summary Information Signal or Summary Signal or Summary Information: A Signal that conveys properties of other Signals and/or of the Signal Sequence. Various types of Summary Information include,
Last Reference Summary Information: Summary Information about a Referenced Object Signal that identifies a position in the Streamable Signal Sequence of the last Referencing Object Signal containing an Object Reference to the Referenced Object Signal.
Memory Requirement Summary Information: Summary Information to convey the amount of memory that will be required to process a given Streamable Signal Sequence.
Page Order Summary Information: Summary Information indicating order of pages in a given Streamable Signal Sequence.
Shared Object Summary Information: Summary Information indicating whether a given Object Signal is shared by having more than one Object Reference to such Shared Object. Such a Shared Object will have more than one Predecessor Object.

An Object that is not a Shared Object can be discarded immediately after processing.

### BRIEF DESCRIPTION OF THE DRAWINGS

FIG. 1 is a block diagram of a system for transforming an Arbitrary Order Signal Sequence into a Streamable Signal Sequence in accordance with the present invention.

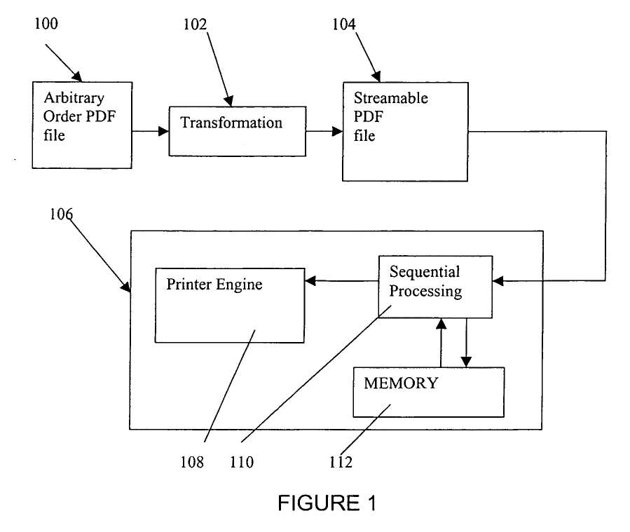

FIG. 2 illustrates the network of references between the Objects of Table 1 below, in accordance with the present invention.

FIG. 3 illustrates the network of references between the Objects of Table 6 that includes the refinement of splitting Object D after the reference to Object I into Object D0 and Object D1 in accordance with the present invention.

FIG. 4 is illustrates the network of references between the Objects of Table 7 that includes the refinement to replicating Object J into Object J0 and Object J1 in accordance with the present invention.

FIG. 5 illustrates the network of references between the Objects of Table 8 that includes the refinement of replicating Objects L and M into Objects L0, L1 and Objects M0. M1, in accordance with the present invention.

### DETAILED DESCRIPTION

The data optimization method of the invention is comprised of the following methodology:

STEP 1. Determine the network of references between Signals in the Original Input Signal Sequence;

STEP 2. Determine a preliminary Signal Sequence containing the Object Signals from the Original Input Signal Sequence based on reducing the storage required to process Object Signals that are referenced more than once (“Shared Objects”). The preliminary Signal Sequence is derived from the network of references between Object Signals in the Original Input Sequence.

In particular, Referenced (i.e., Successor) Objects that are shared are placed in the preliminary Signal Sequence prior to the first reference to such shared Object. A Referenced Object that is not shared is placed before the Referencing (Predecessor) Object if it is smaller than the portion of the Predecessor Object following the reference to the non-shared Referenced Object. The latter portion is referred to herein as the “tail” portion of the Referencing Object. That is, the tail portion of a Referencing Object is the portion of the Referencing Object following the reference to the Referenced Object. A Referenced Object that is not shared is placed after the Referencing Object if it is larger than the tail portion of the Referencing Object. Referencing Objects that reference more than one Referenced Object have a plurality of tail portions each associated with a respective reference to one of a respective plurality of Referenced Objects.

In most cases a Referenced (Successor) Object is placed before its corresponding Referencing (Predecessor) Object. However, the relationship between Referencing (Predecessor) Objects and Referenced (Successor) Objects is logical, not temporal. That is, a Referenced (Successor) Object may be placed before or after its corresponding Referencing (Predecessor) Object in the Signal Sequence.

In such manner, a preliminary Signal Sequence that will form the basis of a Second Signal Sequence is derived from the Original Input Signal Sequence.

STEP 3. Determine Summary Information about Object References from each Object Signal in the preliminary Signal Sequence to other Object Signals in the preliminary Signal Sequence, where the Summary Information for each Object Signal is an indication of whether the Object Signal is referenced by a subsequent Object in the preliminary Signal Sequence and the position of the last reference to each Object Signal. Various types of Summary Information is described below.

STEP 4. Write the Summary Information into the preliminary Signal Sequence to generate the desired Second Signal Sequence.

The above steps transforming an Arbitrary Order Signal Sequence into a Streamable Signal Sequence may be accomplished “on the fly” starting with the Arbitrary Order Signal Sequence as the Input Signal Sequence and streaming the resulting Streamable Signal Sequence to a printer. Alternatively, the Arbitrary Order Signal Sequence may be preprocessed into the Streamable Signal Sequence, which is then stored in a Data File to be later streamed to the printer. In alternative hybrid approaches, some of the steps, such as determining the desired order of Objects and the associated Summary Information, may be preprocessed and stored in a file that is later used in conjunction with the Objects in the Original Input Signal Sequence to generate the Streamable Signal Sequence to the printer.

Determination of the Network of References and Summary Information

The method to determine the network of references within a Structured Signal Sequence involves analysis of the Original Input Signal Sequence to find the references to Objects. The analysis consists of examining Objects as they are processed in order to locate the Object References within an Object to other Objects in the Original Input Signal Sequence. The processing step to determine the network of references within Object Signals to other Objects does not require processing of all information within Objects; but only the reference information between Objects.

The information compiled for each Object is:
(a) The Object that last referenced each Object (if any)
(b) The order of Objects as they will be written to the transformed Signal Sequence. The order is established sequentially as each Object is completely processed so that all Referenced Objects (Successor Objects) will precede each Predecessor Object in the order of Objects.
(c) A true or false value (Summary Information) that indicates whether or not an Object is referenced more than once (a “Shared Object”). The “true” value for an Object indicates that an Object is referenced by more than one Object.

When an Object is first encountered during this preparation step, the “last reference” value (datum a) is set to a value that indicates, “not required” and the “shared” value (datum c) is set to false. When the first Object Reference to an Object is found, the “last reference” value will be set to the Object of the Referencing Object. Subsequently during the analysis, when an Object Reference is found, the “last reference” information for the Referenced Object will be replaced with the information identifying the Object for the Object performing the Object Reference and the “shared” value for the Object being referenced will be set to true. If an Object is referenced by another Object that is referenced more than once, the lower level Objects will be flagged as shared as well.

The Object Reference may be an abstract identifier or key, or may be the position of the Object in the Signal Sequence from the start of the Signal Sequence.

The Last Reference Summary Information for every Object can be maintained in a variety of data structures including a list, table, or associative data structure keyed by Object Identifier.

If the Object has not been previously processed, which will be the case if the “last reference” information (datum a) for the Object contains the “never referenced” value, then once all references contained within an Object are processed, the Object Identifier is appended to (written to the end of) the ordered list of Object Identifiers (datum b).

The Objects that are never referenced during processing are not part of the network of references being optimized and the order of such Objects in the Streamable Signal Sequence makes no difference since the order will not affect the memory usage during sequential processing.

Once the Original Input Signal Sequence has been completely processed in accordance with the present invention, the order of Object Identifiers (datum b) will correspond to an order of Object Signals where references within an Object will refer to Objects earlier in the in the order (backward references). To allow subsequent processing to initiate processing prior to storing the entire Signal Sequence, the initial Object processed during the transformation step will be written first rather than last.

If the Original Input Signal Sequence can be processed in more than a single order, then the order selected during the analysis will correspond to the order for which the storage needed during subsequent processing will be reduced and can be estimated accurately.

Production of the Optimized Signal Sequence

The basic method of producing the Second Signal Sequence consists of:
(a) Writing the Start Signal at the beginning of the Second Signal Sequence
(b) Writing the root Object Signal (the Predecessor Object to all Objects to be processed).
(c) Writing the Objects to the Second Signal Sequence in the order contained in the order of Objects established during processing (datum b in step 1).

Process the last reference information (datum a of step 1) to determine Last Reference Summary Information and insert this into the Second Signal Sequence.

The last reference information collected during step 1 will be the Object Identifier of the direct Predecessor Object of the latest reference to each Object. However the Summary Information will require the position (and thus the order) of the latest reference. If the Predecessor Object is not a Shared Object, then the order/position of the Predecessor Objects will be unique and will be the order/position of the latest reference. If the Predecessor Object or any Predecessor Objects is a Shared Object, then the order/position of latest reference will be the latest order of any of the Predecessor Objects.

Determination of the latest reference information will require processing all Objects in the list to adjust the latest reference order of each Object with respect to the latest order of any Predecessor Object.

Writing the Summary Information

The Summary Information that indicates the latest reference in the second Signal Sequence is represented by the “last reference” information collected for each Object in step 1 (datum b). This information is written to the second Signal Sequence as Last Reference Summary Information. The specific form of the Summary Information in the Signal Sequence may take a variety of forms.

In general, the Summary Information about the last reference to an Object should precede the Object that contains the final reference, since subsequent processing will need to retain any Objects that may be referenced later until the Summary Information is processed.

In some cases, the Summary Information will be written in entirety near the beginning of the second Signal Sequence, but this requires that the Summary Information be retained in storage during subsequent processing for all Objects until the last reference Object for each Object has been processed at which point portions of the Summary Information can be released from retained storage.

More optimally, if the Signal Sequence allows for multiple occurrences of Summary Information, the Summary Information for an Object that may be referenced more than once will be placed immediately before the Object that last references the Referenced Object, thus this subset of Summary Information will be smaller than the complete set of Summary Information about all Objects, and will only need to be retained in storage during the processing of one Object.

### EXAMPLE EMBODIMENT OF THE INVENTION

The example Original Input Signal Sequence is shown in a tabular form in Table 1 below:

TABLE 1

| Object | Contents |
|---|---|
| A | . . . ref: B . . . ref: C . . . ref: D . . . ref: E . . . ref: F . . . ref: |
| | G . . . |
| B | . . . ref: H . . . |
| C | . . . ref: L . . . |
| D | . . . ref: I . . . ref: J . . . |
| E | . . . ref: J . . . |
| F | . . . ref: M . . . |
| G | . . . ref: K . . . |
| H | . . . ref: L . . . |
| I | . . . |
| J | . . . |
| K | . . . ref: M . . . |
| L | . . . ref: N . . . |
| M | . . . ref: O . . . |
| N | . . . |
| O | . . . |

In Table 1, references to another Object are shown as “ref: X” where X is the Object Identifier of the Object being referenced. The “.” characters in Table 1 represent contents of the Object other than references. The different number of “.” characters illustrate the amount of information, equivalent to the amount of storage needed for the Object.

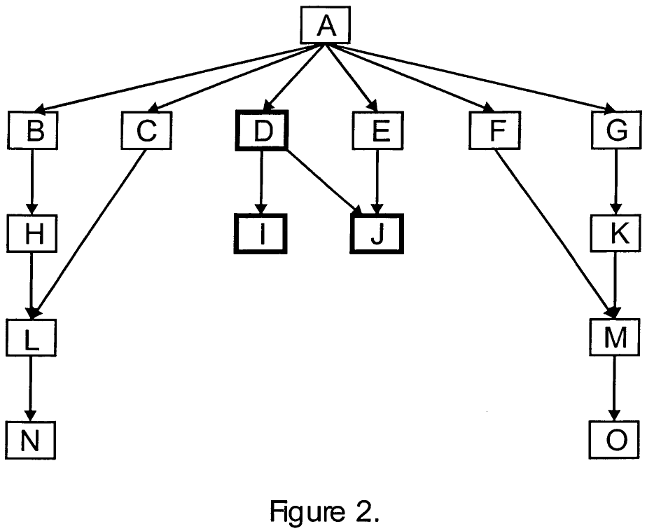

FIG. 2 illustrates the network of references between the Objects of Table 1, where the lines connect the Predecessor Object to the Successor Object in each Object Reference and the arrowhead is placed at the Successor Object.

When the sequence in Table 1 is processed sequentially, Object A is initially processed sequentially, however once the reference to Object B is encountered in Object A, processing cannot continue without the information in Object B, therefore processing of the remainder of Object A must be deferred and the Input Signal Sequence must be searched for Object B.

Assuming that the sequential processing does not have the information that there will be no subsequent references to an Object, the entire Object must be retained in storage.

Object B immediately follows Object A in the above example, so at this point the only Object that is retained in storage is the portion of Object A following the reference to Object B.

Object B is then processed, initially sequentially, until the reference to Object H is processed. The entire contents of Object B must be retained in storage in case it is required subsequently.

Processing cannot continue until Object H is found in the Input Signal Sequence. The next Objects, C, D, E, F, and G must also be retained in storage at which point Object H is found.

Object H is then processed (and retained in storage). As Object H is processed, a reference to Object L is encountered, so further processing of Object H is deferred and it is retained in storage while the Input Signal Sequence is searched for Object L. Objects I, J and K are also retained in storage as they are encountered while searching for Object L.

Object L is then processed (and retained in storage). As Object L is processed, a reference to Object N is encountered, so further processing of Object L is deferred and it is retained in storage while the Input Signal Sequence is searched for Object N. Object M is also retained in storage as it is encountered while searching for Object N.

Object N can then be processed, and processing can resume from the stored Object L. Similarly, the remainder Object L can be processed, then processing can continue for Object H, then Object B.

At this point processing of Object A can resume. At some point the reference to Object C will be encountered. Object C is already retained in storage, so processing can continue without requiring any more information from the input sequence.

Similarly, processing can proceed using stored Objects until Object O is referenced from Object M, at which point the Input Signal Sequence must be searched for Object O. Since the Input Signal Sequence has been previously processed and stored up to the end of Object N, Object O will be the next Signal from the input sequence.

Object O can be processed and retained in storage, and processing can resume for Object M, followed by resuming processing for Object F, then Object A. All further processing of Objects (G, K, M, and O) can proceed without requiring any further information from the input sequence.

Observation of this sequential process example demonstrates two opportunities for optimization:
a) Eventually, the entire input sequence needs to be retained in storage since it is not known whether or not Objects may be referenced during subsequent processing;
b) The processing must stop while the Input Signal Sequence is searched to find the Object of a reference. Sometimes many Object Signals must be retained in storage without processing in order to advance to the needed Object in the Input Signal Sequence.

After processing according to the above steps, the results of the data collected are shown in Table 2 below.

TABLE 2

| Object | last reference | shared | order |
|---|---|---|---|
| A | — | false | 15 |
| B | A | false | 4 |
| H | B | false | 3 |
| L | C | true | 2 |
| N | L | true | 1 |
| C | A | false | 5 |
| D | A | false | 8 |
| I | D | false | 6 |
| J | E | true | 7 |
| E | A | false | 9 |
| F | A | false | 12 |
| M | K | true | 11 |
| O | M | true | 10 |
| G | A | false | 14 |
| K | G | false | 13 |

The resulting Signal Sequence reordered so that the root Object Signal is first, followed by the remaining Objects where all references are backward references is then:
A N L H B C I J D E O M F K G

The next step is to process the “last reference” information as in step 4. The need for this can be observed because the last reference for Object N is listed as Object L, but Object L is referenced by Object C, so Object N will also be referenced while processing Object C. Also, the last reference for Object O is listed as Object M, which is referenced while processing Object K which is last referenced while processing Object G. Thus, Objects L and N must be retained until last used in Object C, while Objects M and O must be retained until last used in Object K as it is processed from Object G.

The processing of each Object's last reference information proceeds by:
a) If an Object identified as an Object's last reference information has the shared flag set to true, then
b) Record the Object under examination and record the last reference of the Object as the provisional last reference
c) If the Object specified by the provisional last reference is shared, then replace the record for the provisional last reference with the last reference value and repeat this step (recursively)
d) If the order of the last reference for the Object under examination is before the order of the provisional last reference, replace the last reference value for the Object under examination with the Object specified by the provisional last reference.

During this processing for Object N, its last reference is Object L which is shared, so using step b, record the Object under examination as Object N, and record the provisional last reference as Object L. Since Object L is shared, replace the contents of the provisional last record with its last reference, Object C according to step c. Since Object C is not shared then step d is applied. Object C is in order position 5. Since the order of Object C follows Object N (5 follows 2), the last reference information for N is updated to be Object C.

| Object | last reference | shared | order |
|---|---|---|---|
| N | C | true | 1 |

The Summary Information resulting from the above last reference processing is shown in Table 3 below:

TABLE 3
Summary Information:
Non-shared Objects: A B C D E F G H I K

| Shared | Last reference |
|---|---|
| Object | from Object |
| J | E |
| L | C |
| M | K |
| N | C |
| O | K |

If the above information is represented with Summary Information placed after the Objects that contain the final reference, then the information can be illustrated as shown in Table 4 below:

TABLE 4

| | |
|---|---|
| Object | Contents |

<not shared: A B C D E F G H I K>

| | |
|---|---|
| A | . . . ref: B . . . ref: C . . . ref: D . . . ref: E . . . ref: F . . . ref: |
| | G . . . |
| N | . . . |
| L | . . . ref: N . . . |
| H | . . . ref: L . . . |
| B | . . . ref: H . . . |
| C | . . . ref: L . . . |

<no longer shared: L, N>

| | |
|---|---|
| I | . . . |
| J | . . . |
| D | . . . ref: I . . . ref: J . . . |
| E | . . . ref: J . . . |

<no longer shared: J>

| | |
|---|---|
| O | . . . |
| M | . . . ref: O . . . |
| F | . . . ref: M . . . |
| K | . . . ref: M . . . |
| G | . . . ref: K . . . |

<no longer shared: M, O>

In the example nomenclature, Objects listed in Summary Information as “no longer shared” can be freed (discarded) as the Summary Information is encountered in the Input Signal Sequence Sequence. Objects listed in the Summary Information as “not shared” can be discarded (i.e., erased or deleted) from storage as soon as they have been processed.

The Summary Information can be represented in the transformed Signal Sequence in a variety of other ways. Some methods of placing the Summary Information may be preferred in specific embodiments. Examples of some of these other methods for placing the Summary Information and features of these methods follow.

A) Summary Information is placed as a single collection near the beginning of the transformed Signal Sequence. This method does require that the Summary Information be retained in storage for all of the Objects. Last reference information for Shared Objects is included, however, it can be assumed that any Objects with no last reference information are not shared. This may result in a smaller amount of Summary Information. This placement method may also be required for some embodiments.

B) Summary Information for Objects that are not shared is placed immediately before or within the non-Shared Object. Last reference information follows the last use of any Shared Objects. This method has the smallest amount of storage for the Summary Information itself, since the Summary Information is placed so that it is encountered in the transformed Signal when it is relevant to the processing of the current Object.

Processing the Transformed Optimized Signal Sequence.

When the Streamable Signal Sequence is processed sequentially, Object A is initially processed, however once the reference to Object B is encountered in Object A, processing cannot continue without the information in Object B, therefore processing of the remainder of Object A must be deferred (stored) and the streamable Signal must be searched for Object B.

When searching for Object B, Objects N, L, and H will be encountered in the streamable sequence and will be retained in storage, followed by Object B. Processing of Object B will begin, and when the reference for Object H is encountered, Object H will be processed from retained storage.

As Object H is processed, the reference to Object L will be detected. Object L will be processed from retained storage.

As Object H is processed, the reference to Object L will be detected. Object L will be processed from retained storage.

Object N is then processed, followed by the portion of Object L following the reference to Object N. When Object L has been completely processed, processing continues with the portion of Object H following the reference to Object L. Note that Objects L and N are not identified as “not shared”, so these Objects are retained in storage after being processed.

Once all of Object H has been processed, it can be removed from retained storage since it is identified as not shared. After processing Object H, processing continues with the portion of Object B following the reference to Object H. As with Object H, Object B is identified as not shared, so can be removed from retained storage once it has been processed.

Also note that when references are encountered to another Object, and processing of the current Object must be placed in retained storage for later processing, if the Object being suspended is not shared, only the remaining (tail) portion of the Object needs to be retained in storage since the initial portion and the reference will not be required by subsequent processing. This applies to Objects A, B and H. Thus the maximum amount of retained storage up to this point will contain the ‘tail’ portion of Object A, the tail of Object H, and the tail of Object B, along with Objects L and N in entirety.

Following the completion of processing for Object B, processing of the remainder of Object A continues until the reference to Object C is encountered. Object C is not contained in retained storage, so the streamable sequence is searched. The Summary Information indicating the last reference is pending for Objects L and N. This Summary Information is retained in storage. Next Object C is encountered in the streamable sequence.

Object C is processed until the reference to Object L is encountered. The remainder of Object C is retained in storage and Object L is processed from retained storage.

While processing Object L, the reference to Object N is encountered. Object N is then processed, after which point processing of Object L continues, and similarly, processing of Object C.

Once Object C is processed, Objects C, L and N as well as the Summary Information related to Objects L and N can be removed from retained storage. At this point only the remaining portion of Object A (following the reference to Object C) is required in retained storage.

Processing of Object A is resumed and a reference to Object D is encountered. The portion of Object A following the reference is retained in storage and the streamable sequence is searched for Object D. Objects I and J are retained in storage prior to encountering Object D in the streamable sequence.

As Object D is processed, the references to Objects I and J are encountered. Objects I and J are processed from retained storage. Object I is not shared, so it can be removed from retained storage once it has been processed. Object D was not shared, so also is not retained in storage.

Next processing of Object A is resumed and a reference to Object E is encountered. The portion of Object A following the reference is retained in storage and the streamable sequence is searched for Object E. Objects E is encountered next in the streamable sequence and is processed. When Object J is referenced from Object E, Object J is processed from retained storage. Once Object E has been completely processed, Object J can be removed from retained storage according to the Summary Information preceding Object E. Note that Object E is not shared so does not need to be retained in storage.

Once again processing of Object A is resumed and a reference to Object F is encountered. The portion of Object A following the reference is retained in storage and the streamable sequence is searched for Object F. Objects O and M are retained in storage prior to encountering Object F in the streamable sequence.

While processing Object F, Object O, then Object M are processed from retained storage. Object F is not shared so does not need to be retained in storage.

Processing of Object A is resumed and a reference to Object G is encountered. The portion of Object A following the reference is retained in storage and the streamable sequence is searched for Object G. Object K is retained in storage prior to encountering Object G in the streamable sequence.

When Object K is referenced from Object G, Object K is processed from retained storage, as are Objects M, and Object O (Object M is referenced from Object K and Object O is referenced from Object M). Once Object G has been completely processed, Objects M and O can be removed from retained storage according to the Summary Information preceding Object G. Note that Object G is not shared so does not need to be retained in storage.

Refinement #1—Object Streaming.

While the methods described above transform the input sequence such that it can be processed without retaining all of the Objects in storage, further transformation can reduce the need for retained storage.

Objects that are not shared can be processed without being retained in storage. Rather than placing all Objects that are not shared before the Object that references each, this refinement method places the Object that is not shared immediately following the Referencing Object.

This refinement allows the transformed Signal to be processed without retaining the Object that is not shared in storage; however, the portion of the Referencing Object following the reference does need to be retained in storage.

From this requirement, the refinement #1 can be selectively applied so as to minimize the retained storage. An Object that is not shared is only streamed (placed following the reference) if it is larger than the (tail) portion of the Referencing Object following the reference.

Refinement #1 Object Streaming, Applied to the Example.

Applying the Object streaming refinement to the example, Objects that are not shared are placed immediately following the reference as shown in Table 5 below.

TABLE 5

| | |
|---|---|
| Object | Contents |

<not shared: A B C D E F G H I K>

| | |
|---|---|
| A | . . . ref: B . . . ref: C . . . ref: D . . . ref: E . . . ref: F . . . ref: |
| | G . . . |
| N | . . . |
| L | . . . ref: N . . . |
| B | . . . ret: H . . . |
| H | . . . ref: L . . . |
| C | . . . ref: L . . . |

<no longer shared: L, N>

| | |
|---|---|
| J | . . . |
| D | . . . ref: I . . . ref: J . . . |
| I | . . . |
| E | . . . ref: J . . . |

<no longer shared: J>

| | |
|---|---|
| O | . . . |
| M | . . . ref: O . . . |
| F | . . . ref: M . . . |
| G | . . . ref: K . . . |
| K | . . . ref: M . . . |

<no longer shared: M, O>

With the above sequence (A N L B H C J D I E O M F G K) that has been transformed including the refinement #1 optimization, Objects H, I, and K can be processed without being retained in storage. Note that portions of the Referencing Objects (B, D and G, respectively) need to be retained in storage, where the portion of the Referencing Object is that following the reference.

Refinement #2—Object Splitting.

Since refinement #1 requires the trailing portion of Referencing Objects to be retained while processing streamed Objects (Objects that are not shared placed following the reference), a further optimization may be possible if the original Referencing Object is split into two Referencing Objects such that the reference to a streamed Referenced Object is at the end of the first of the two Referencing Objects. Then the streamed Referenced Object will be placed between the two Referencing Objects created by splitting the first Referencing Object.

This approach requires that all references to the Referencing Object that is to be split be changed to two references, consecutively. Also since there is overhead associated with splitting Referencing Objects (creation of an extra reference in the Predecessor Object to be split), this method is optimally applied only to those Referencing Objects where the reduction in retained storage requirement is greater than the increased storage required for the additional Predecessor Object created by the split Referencing Object.

Refinement #2 Applied to the Example.

While any of the Referencing Objects that reference an Object that is not shared can be split, this example case will apply the refinement to splitting Referencing Object D after the reference to Object I into D0 and D1. Illustration of this refinement is shown in Table 6 below.

TABLE 6

| | |
|---|---|
| Object | Contents |

<not shared: A B C D₀ D₁ E F G H I K>

| | |
|---|---|
| A | . . . ref: B . . . ref: C . . . ref: D₀ ref: D₁ . . . ref: E . . . ref: |
| | F . . . ref: G . . . |
| N | . . . |
| L | . . . ref: N . . . |
| B | . . . ref: H . . . |
| H | . . . ref: L . . . |
| C | . . . ref: L . . . |

<no longer shared: L, N>

| | |
|---|---|
| J | . . . |
| D₀ | . . . ref: I |
| I | . . . |
| D₁ | . . . ref: J . . . |
| E | . . . ref: J . . . |

<no longer shared: J>

| | |
|---|---|
| O | . . . |
| M | . . . ref: O . . . |
| F | . . . ref: M . . . |
| G | . . . ref: K . . . |
| K | . . . ref: M . . . |

<no longer shared: M, O>

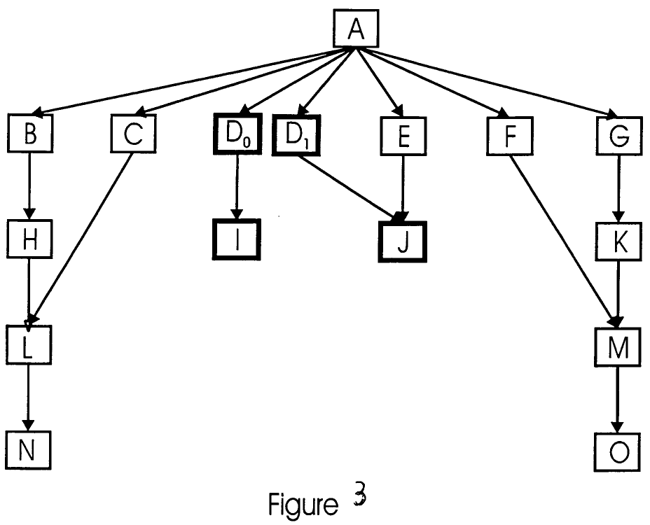

FIG. 3 illustrates the network of references between the Objects of Table 6, where the lines connect the Predecessor Object to the Successor Object each reference and the arrowhead is placed at the Succesor Object. The transformed Signal Sequence after including the refinement of object splitting is:
A N L B H C J D0 I D1 E O M F G K

With this refinement applied to Object D, Object D0 is not shared, so can be streamed without being retained in storage, and when the reference to Object I is encountered, there is no remaining information in Object D0 that needs to be retained in storage. The streamable sequence is searched for Object I, which is next in the streamable sequence. Since Object I is not shared, it also can be streamed without being retained in storage. The resulting reduction in required storage corresponds to the size of Object D1 (less the overhead).

Refinement #3—Object Replication.

Further reduction in retained storage required while processing the transformed (streamable) Signal Sequence if the length of the streamable sequence is less important than the retained storage requirement.

Objects that are shared can be replicated into Objects that are not shared, and as such can be streamed using principle of refinement #1. There may be overhead associated with the Object Replication such as the need to retain a larger list of Objects that are not shared, so this refinement may be selectively applied to those instances where the reduction of retained storage is greater than the increase due to the overhead for a particular Signal Sequence.

Note that if the Predecessor Object to a replicated Object is shared, the Predecessor Object also must be replicated.

Refinement #3 Applied to the Example.

While any of the Referenced Objects that are referenced by multiple Referencing Objects can be replicated, this example case will apply the refinement to replicating Object J into J0 and J1. Illustration of this refinement is shown as a further refinement to refinements 1 and 2 is shown in Table 7 below.

TABLE 7

| | |
|---|---|
| Object | Contents |

<not shared: A B C D₀ D₁ E F G H I J₀ J₁ K>

| | |
|---|---|
| A | . . . ref: B . . . ref: C . . . ref: D₀ ref: D₁ . . . ref: E . . . ref: |
| | F . . . ref: G . . . |
| N | . . . |
| L | . . . ref: N . . . |
| B | . . . ref: H . . . |
| H | . . . ref: L . . . |
| C | . . . ref: L . . . |

<no longer shared: L, N>

| | |
|---|---|
| J | . . . |
| D₀ | . . . ref: I |
| I | . . . |
| D₁ | . . . ref: J₀ . . . |
| J₀ | . . . |
| E | . . . ref: J₁ . . . |
| J₁ | . . . |
| O | . . . |
| M | . . . ref: O . . . |
| F | . . . ref: M . . . |
| G | . . . ref: K . . . |
| K | . . . ref: M . . . |

<no longer shared: M, O>

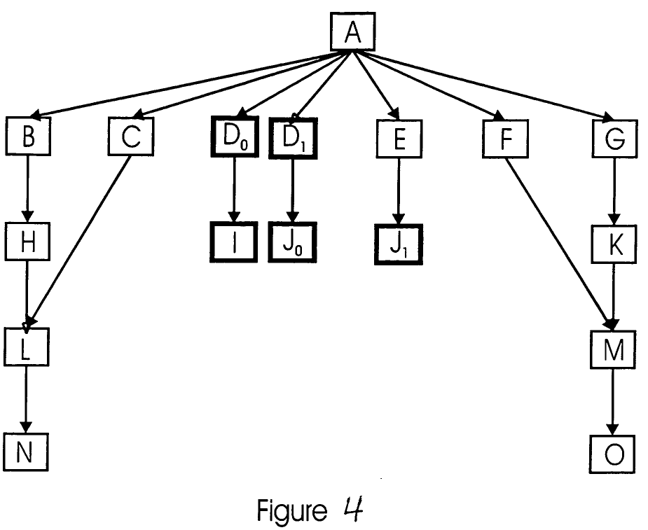

FIG. 4 illustrates the network of references between the Objects of Table 7, where the lines connect the Predecessor Object to the Successor Object in each reference and the arrowhead is placed at the Successor Object. The transformed Signal Sequence after including the refinement of object replication is:
A N L B H C J D0 I D1 J0 E J1 O M F G K

With this refinement applied to Object J, Object J0 is not shared, so can be streamed without being retained in storage, and similarly Object J1 is not shared, so can be streamed without being retained in storage. The resulting reduction in required storage corresponds to the size of Object J (less the overhead).

If refinement #3 is applied to Object N, then Object L must be replicated as well. Similarly, if refinement #3 is applied to Object O, then Object M must be replicated. Applying refinement #3 to Objects N and O is shown in Table 8 below.

TABLE 8

| | |
|---|---|
| Object | Contents |

<not shared: A B C D₀ D₁ E F G H I J₀ J₁ K L₀ L₁ M₀
M₁ N₀ N₁ O₀ O₁>

| | |
|---|---|
| A | . . . ref: B . . . ref: C . . . ref: D₀ ref: D₁ . . . ref: E . . . ref: |
| | F. . . ref: G . . . |
| B | . . . ref: H . . . |
| H | . . . ref: L₀ . . . |
| L₀ | . . . ref: N₀ . . . |
| N₀ | . . . |
| C | . . . ref: L₁ . . . |
| L₁ | . . . ref: N₁ . . . |
| N₁ | . . . |
| D₀ | . . . ref: I |
| I | . . . |
| D₁ | . . . ref: J₀ . . . |
| J₀ | . . . |
| E | . . . ref: J₁ . . . |
| J₁ | . . . |
| F | . . . ref: M₀ . . . |
| M₀ | . . . ref: O₀ . . . |
| O₀ | . . . |
| G | . . . ref: K . . . |
| K | . . . ref: M₁ . . . |
| M₁ | . . . ref: O₁ . . . |
| O₁ | . . . |

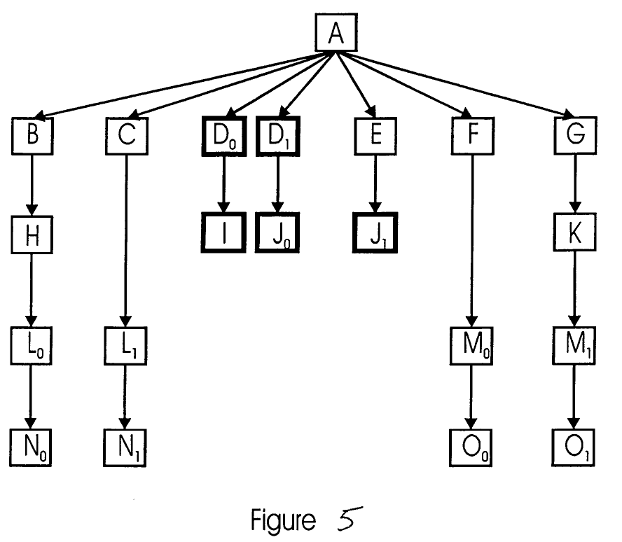

FIG. 5 illustrates the network of references between the Objects of Table 8, where the lines connect the Predecessor Object to the Successor Object in each reference and the arrowhead is placed at the Successor Object. The transformed Signal Sequence after including the refinement of object replication is:
A B H L0 N0 C L1 N1 D0 I D1 J0 E J1 F M0 O0 G K M1 O1

Thus all of the Objects are not shared and the retained storage requirement reduces to the portions of any Object following the reference to some other Object.

Note that once all Shared Objects have been replicated, the Summary Information inserted into the transformed sequence can be reduced to some bit of information that implies that all of the Objects are not shared.

Refinement #4—Minimal Change to Meet Storage Requirement Goals.

If there is a specific storage limit value that can be used while transforming the Input Signal Sequence, then the decision to apply refinements that modify and/or add Objects can be guided by the comparing the amount of storage that is required at a given point in the streamable Signal against the limit value for storage and only using refinements 3 (Object Splitting) or refinement 4 (Object Replication) if required to keep the storage below the limit.

Advanced forms of this refinement may select particularly large Objects for replication, so that a more frequent application of Object Splitting or Object Replication for smaller Objects can be avoided.

Refinement #5—Adding Storage Estimate to the Summary Information.

While transforming the Input Signal Sequence Sequence, the storage required during processing of the transformed streamable Signal can be estimated at each point in the Streamable Signal Sequence. The information retained in storage is comprised of Shared Objects and the portions of Objects that follow a reference to another Object. The maximum amount of storage required during processing of the transformed streamable Signal will be known once the entire Input Signal Sequence has been transformed. There are several methods of estimating the storage requirement during processing of the transformed Signal, but it is adequate to assume that there is a small amount of overhead for each item in storage and that the amount of storage will not exceed the size of the Object in the Signal Sequence. In some cases the storage required may be less, for example if the Object can be compressed as it is stored.

If the maximum storage requirement estimate is placed in the transformed Signal Sequence, this information may be useful in processing the transformed streamable sequence. Examples of the utility of the storage estimate information include:
A) Allows a processor of the transformed Signal to determine if adequate storage is available to complete processing of the Signal. This will allow aborting processing early, avoiding the consumption of processing or other resources (such as media).
B) Allows the transformed Signal to be examined and directed to a processor that has adequate storage resources. A system using this information would have multiple processors and would have the information about the storage capacity of each. Streamable Signals would only be directed to processors with adequate storage.
C) If no processors are available with adequate storage, it may be possible to process the transformed Signal to apply storage reductions methods described herein to further reduce the storage requirement for the Signal. It may be that the previous transformation used a storage requirement goal (along the lines of refinement #4) that resulted in less storage reduction than could be achieved by reapplying the transformation method with a smaller storage requirement goal.

### EMBODIMENT OF THE INVENTION APPLIED TO PDF FILES

The following description uses terminology that is defined and used in the “PDF Reference third edition” published by Adobe Systems Incorporated as cited in the “Other References” section above.

Embodiment of the invention for optimization of PDF (Portable Document Format) applies the general elements of the invention using the following

The “Atomic Data Element” is an octet.

The “start Signal” is the line of text beginning with “% PDF” at the beginning of a PDF file.

*An “Object Signal” is a PDF Object, consisting of the “obj” through the “endobj”. The form of this is an Object Identifier (number), whitespace, a generation number, whitespace, and the word “obj” followed by whitespace. The Object Signal follows the whitespace after the ‘obj’ keyword. The “endobj” keyword is preceded and followed by whitespace.

A “PDF Object Identifier” is a PDF Object number followed by a PDF Object generation number.

An “Object Reference” is a PDF Object Identifier followed by the “R” operator, within any kind of PDF Object other than a stream. An “Object Reference” may also be indirect via a “named resource”, requiring the examination of the contents of another Object to resolve the named resource (Resources information) to an Object Identifier. It is important to note that the information associating the name of a named resource with a PDF Object Identifier is not of itself a reference to the Object.

The “Summary Information” is comprised of PDF cross-reference tables, consisting of the “xref” line through the integer following the “startxref” line, including the trailer dictionary. Multiple “xref” tables are linked together using the “Prev” element of each trailer dictionary.

The “end Signal” is the “% % EOF” line at the end of a PDF file.

Portable Document Format Characteristics

The PDF specification requires random access to PDF files in order to render them. Linearized (“optimized”) PDF is designed to require fewer seeks in the file, but still requires random access. The random access requirement implies that any printer capable of accepting PDF directly must store the entire file before starting printing. This is required since the specification places the position of the start of a linked list of xref (index) tables immediately preceding the EOF.

It would be useful to have PDF be a native language for printers. Adobe Systems has stated that PDF is the native language for some of its printing software products. Nevertheless, it appears that printers cannot process the PDF language unless they have a large amount of storage available, typically a hard disk.

The method and refinements of the present invention can readily be applied to transformation of Portable Document Format (“PDF”) Signal Sequences (typically stored as files) in order to reduce the storage requirement for specific subsequent processing. In particular, the PDF thus transformed would be suitable for subsequent processing by a printer or page renderer with limited storage available.

The method of the present invention allows a processing device with limited storage to render pages of a very large PDF document in the order chosen during the optimization transformation of the subject method with no extra storage beyond that required during a single page, even for a document of thousands of pages.

The key points of the method of the invention for this embodiment are:
The start Signal (% PDF header) is followed by an Object that identifies the PDF as one that has been transformed by the method (“Streamable”). This may take the form of an Object containing a dictionary with keys /Type/Streamable and with other key/value pairs such as /Root Object-reference.
The Root of the page tree (refer to PDF Reference) can be located prior to the end of the file.

The method of the invention is applied to Pages to be subsequently processed in a specific order such as first to last, last to first, all odd pages followed by all even pages. Note that a PDF file transformed to minimize storage for a specific order can later be transformed using the method of the invention to minimize storage for some other order of pages.

All Objects needed prior to processing each page to be rendered in the specific optimized order are present in the sequence prior to the reference that requires those Objects for processing. This includes: Info, Catalog, . . . prior to the first page and Resources specific to each page prior to that page. Thus the minimum set of constraints on Object ordering that allows a PDF file to be rendered with minimum retained information is:
The Info dictionary must come first, followed by the Catalog.
The following Objects must appear before each page:
The branch of the Pages tree, in order from the root to the Page Object. (Pages Objects with multiple successors only appear before their first successor.)
The Page Object.
The Resource dictionaries for all Page(s) Objects on the branch, and all Objects they reference. (Resources referenced from multiple pages only appear before the first page that references them.)
The Contents stream(s) for the page.

Subsequently the transformation method will store Objects such as fonts, images or forms as they are encountered. The transformation may optionally compress Objects in storage even if the Object in the sequence was not compressed. Also retained Objects encoded as other than binary (for example ASCIIHex, ASCII85 or eexec) may optionally be decoded into binary prior to being stored or compressed for storage.

The /Contents stream for a page begins rendering each page. Applying refinement #2, the Contents stream will usually be preceded by an xref to indicate that the content stream (which is usually unique to each page) can be consumed as it is processed and need not be retained. This xref may also contain index information for other Objects that are only used once on the page. This allows single use fonts and images as well as the content stream (which may consist of several segments) to be processed sequentially without requiring intermediate storage.

As the content stream or other references are transformed, other xref (index Signals) will be interspersed to convey the information as to which retained Objects will not be required for subsequent processing or may be discarded without being stored or discarded if they were previously stored.

Placement of the xref tables to indicate final use of a retained Object may or may not immediately follow the last reference in another Object since the interruption of a contents stream and imposition of an xref table imposes an overhead in file size and processing time for little or no gain. Typically the xref will be placed following a completed Object (stream) and will precede any new retained Objects.

Objects which are not required for the specific processing will generally occur following the information for the last page to be processed, for example rendering pages to produce visible output in a certain order does not require bookmarks, thumbnails, and other meta-data. A hint in the initial “Streamable” dictionary might be present to indicate the sequence length (file size) to allow a processor to rapidly skip all such Objects.

The method defines a set of restrictions on the ordering of data in PDF files. PDF files that obey these restrictions are called “streamable”. Printers can render streamable PDF files on the fly, page by page, storing only enough data to render each page and consuming much of the bulky data consisting of images and fonts as it is processed.

Like linearized PDF, streamable PDF imposes no restrictions on the content of the file. Any PDF file can be made streamable without adding, removing, or modifying any part of its content although some of the refinements to the method may represent the content as several segments to be processed sequentially.

While general PDF processing software that is not “streamable-aware” will not be able to process the resulting PDF document until the document is complete (because the xref table may appear at the very end of the document), streamable-aware PDF RIPs and other software that recognize streamable PDF specially can consume and render it page by page.

Note that the optimization is applied to the PDF Objects required to render the document visually. Objects that relate to interactive behavior or to document structure are not needed to render the document and generally will be grouped at the end of the document. If the document is being sent to a printer or other processor that only requires the visual content, the unneeded information may be stripped from the file in order to conserve communication bandwidth.

The Objects required to render a PDF document are:
The Info dictionary, for encryption information if any;
The Catalog Object, for the root of the Page(s) tree;
The Page(s) Objects;
The Resource dictionaries in the Page(s) Objects, and all Objects reachable from those;
The Contents (arrays of) streams in the Page(s) Objects.

Besides any encryption information from the Info dictionary (which will generally not be mentioned further), the Objects required to render a specific page of a PDF document are:
The Page Object, and all ancestral Page Objects (for layout box information and for resources);
The Resource dictionaries in those Objects, and all Objects reachable from those;
The Contents (array of) stream(s) in the Page Object.
   Controlled Discarding and Use of Summary Information

The basic method ensures that a renderer will have the information it needs in order to process each page. However, it does not address the issue of when the renderer can discard information. While the Page(s) Objects can be discarded as soon as they have been processed, resources such as fonts are routinely shared among multiple pages, and cannot be discarded at the end of the page. Contents streams, while normally referenced only from a single page, also can theoretically be shared. Thus, given only the basic plan, the renderer must retain resources and contents streams until the end of the document.

Note that subsequent processing of PDF transformed by the basic method does not need to make use of the xref tables that map PDF Object Identifiers to Object positions in the file, since all Objects are encountered in the file before they are referenced. The PDF specification allows a file to contain multiple, chained xref tables, with no limit on the number of such tables and also with no restriction as the relative position of the Objects and the xref tables that contain the entries for the Objects. Therefore, the appearance of an xref table with an entry for Object N can be used to indicate that there are no references to Object N later in the file—i.e., that Object N is no longer needed and can be discarded from memory. A streamable PDF producer can emit an xref entry for a resource as soon as the producer knows that the resource will not be used again. (The producer always has the option of emitting such an entry and including another copy of the resource later.) Similarly, the producer can and should place an xref entry for a non-shared contents stream (the usual case) immediately after the stream itself. The xref entries for Page(s) Objects can appear immediately after the end of the relevant page.

Refinement #1: Object Streaming—Processing without Storing.

Controlled discarding allows efficient use of renderer memory, by making it possible to discard an Object as soon as the Object is no longer needed. However, the renderer must still read each Object entirely into memory, and retain it until the xref entry appears. In the case of the contents streams for complex pages or (non-shared) large images, this refinement allows processing the data without storing the stream data in its entirety at all.

Being able to process a stream on the fly requires knowing that there is only a single reference to the stream. One method to indicate this in a streamable PDF file is by including the xref entry for the stream Object before the stream itself. (The PDF specification does not require that an xref entry come after the Object it references, and indeed the first xref table in a linearized PDF file points to Objects that appear later in the file.) Thus if the streamable PDF renderer sees an xref entry for an Object that has not yet appeared in the file, the renderer can process the Object while reading it, and not retain it in memory.

Note that the xref entries for all Objects that are not referenced by more than one other Object could be collected into the first xref table present in the PDF file (Signal Sequence) or collected for all non-Shared Objects on a page by page basis, since the xref table for all non-s in an entire document may require excessive storage.

Note that subsequent processing can discard any xref entries for Objects once they have been discarded. Processors that perform this type of storage management on the xref entries may realize significant storage reduction if xref tables are inserted on a page-by-page basis for the singly used Objects.

Refinement #2: Object Splitting—Contents/Resource Interleaving.

Using an early xref entry to indicate non-Shared Objects works well for page contents streams. However, this technique by itself does not address non-shared resources such as images, and possibly fonts or color spaces: these Objects are needed while the page contents are being processed, i.e., during interpretation of the contents stream(s).

One possible approach to this issue is not to identify the contents stream as non-shared, and to follow it immediately with the non-shared resources. The renderer will read and store the entire contents stream, and then read the resources from the file as the stream is being processed. However, there is a better approach that requires a slightly more sophisticated creator of the optimized PDF that relies on the feature that there can be any number of contents streams for a page and multiple contents streams are logically equivalent to a single large content stream.

This refinement divides up the contents stream into multiple streams. In each sub-stream, the last operator references (by name) a non-shared resource—e.g., the last operator is a “Do”, “cs”, “CS”, or “Tf”. As long as the xref entry for that non-Shared Object has preceded the stream, its position is known and it is known to be non-shared (as was discussed in refinement #2). Thus the content stream only need to be stored through the interspersed “endstream endobj” operators before the required Object is located. A streamable-aware PDF processor of a PDF file known to be transformed by this method (Streamable) might discard the “endstream” and “endobj” as they are encountered, obviating the need to store them at all.

An example is shown in Table 9 below.

TABLE 9

[[ xref entry for Objects 3, 5, 10 and 11]]
10 0 obj
<< . . . >> stream
. . .
/lm1 Do
endstream
endobj
11 0 obj
<< . . . >> stream
[[ image data ]]
endstream
endobj

In Table 9, the delimit commentary brackets, not PDF syntax.

At the expense of some additional overhead, including page contents consisting of multiple streams rather than a single one, this approach allows streaming image data as well as page contents.

Refinement #3: Object Replication—Adding Multiple Copies of Shared Objects

Since Objects that are shared need to be retained until the last use, the memory needed for subsequent processing may be larger than is available or desirable, such as processing by a printer without a hard disk and with limited memory. In order to reduce or in many cases, eliminate, the storage needed for retained Objects, this refinement creates additional copies of the Objects that are referenced, up to one copy per reference. The references are altered to refer to the copy, so each reference is only singular and all Referenced Objects, the original and the copies, will immediately follow the reference as in embodiment #3.

Note that this method does not preserve the structure of the original PDF file, since Objects that were shared are no longer shared, and the file is larger, potentially much larger, than the original. Also note that since the structure is changed, it is not possible to re-create the original sharing, although comparison of similarly typed Referenced Objects would allow identical copies to be detected and shared if it was required to reduce the file size.

Not all Shared Objects need to be copied, since this refinement can be applied selectively to those Shared Objects that are particularly large, or in order to achieve some value of the estimated memory that will be needed during subsequent processing. For example, printer information may exist to define the available storage during Streamable PDF processing, and the refinement #4 can be applied selectively to allow the storage required during processing to be less than the amount available in the target printer.

Refinement #6—Identification of PDF File as Streamable

Some of the actions to be taken during subsequent processing to release storage used for Objects requires that the subsequent processing receive the information that the PDF has been transformed by one or several of the methods and refinements of the invention. The transforming of a PDF file according to the method of the invention is said to yield a “streamable” PDF and as such, the refinements above can be assumed to have been applied.

The information that the PDF file is streamable (has been transformed by the method of the invention) can be provided to the subsequent processing “out of band”, such as by naming the file in a particular way, or by adding to information associated with the file (for example, a resource fork), or by prefixing a file transmitted over a communication channel with the information. These methods provide the requisite information, but have disadvantages over the method of this refinement.

The refined method inserts an Object into the PDF file, near the beginning, that is otherwise not referenced by any other Object. The preferred type of this Object is a dictionary that contains the key /Type that has the nametype value /Streamable.

When subsequently processing a PDF file known to be streamable, the processor can avoid access to the end of the file, which may require storage of the entire file if the contents cannot be accessed randomly, but rather can begin storing and processing Objects as they are encountered.

If the PDF file is furthermore identified as having been transformed by refinement #1, then once a stored Object has been identified in an xref table, then the storage for said Object can be released and re-used subsequently. Such memory allocation and re-use methods are well known to those proficient in software engineering practices. A method for identification of a PDF file as having been transformed by this method is discussed as refinement #5.

Similarly, if the PDF file is identified as having been transformed by refinement #2, then Objects that follow an xref table that identifies said Object can be processed without storing. Said Objects are referenced by only one other Object. Note that the reference to an Object from another Object should be near the end of the referencing (Predecessor Object) Object to minimize the storage needed before encountering the referenced (successor) Object.

Note that the estimated storage required to process that transformed ‘streamable’ PDF file can be represented in this same dictionary (refer to refinement #5). An example of such information is a /MaxStorage key followed by an integer value. This information could be used by when processing the Streamable PDF file to:
A) Abort processing immediately if inadequate storage cannot be reserved for the completion of processing before consuming and computation or other resources such as paper on a printer. Often a partial job is not desirable.
B) If a ‘workflow’ system is directing PDF files to several printers, and if the storage capacity of each is known, then a PDF file could be sent to a printer that will be able to completely process the file. This is similar to directing print jobs to printers with certain page size capabilities or with specific finishing options such as duplexers or staplers.
C) If no printers are available with adequate storage capacity, then an attempt can be made to transform the Streamable PDF again to reduce the storage requirement to a value that a specific target processor can provide.

In a PDF file, there is an opportunity to reduce the size of the PDF file as well as the storage required to process the transformed PDF file if indirect Objects are replaced with direct (inline) information wherever possible. This can readily be accomplished at the same time as Objects of the input PDF file are being analyzed and the transformed streamable PDF file is being written.

For example, the /Length element of stream dictionaries can be, and often is, represented as an indirect Object since this allows the PDF creator to:
a) Assign an Object number for the /Length value and place the corresponding indirect reference in the stream dictionary;
b) Write the stream data using the selected Encode filters;
c) Write the resulting length value in the Object reserved for the Length value.

If the stream dictionary contains the Length as a direct value, processing of the stream is more efficient and the Length indirect Object won't need to be stored.

1. A method for processing an Arbitrary Order Signal Sequence having a plurality of Objects and a plurality of Object References between said plurality of Objects, said method transforming said Arbitrary Order Signal Sequence into a Streamable Signal Sequence, said method comprising:
determining a network of references between said plurality of Objects, said step of determining including identifying at least one Referenced Object and a corresponding Referencing Object containing an Object Reference to said Referenced Object; and
placing said Referenced Object in said Streamable Signal Sequence prior to said corresponding Referencing Object, responsive to said determining step, to form said Streamable Signal Sequence.

2. A method in accordance with claim 1, wherein said Referenced Object is a Shared Referenced Object that has a first Object Reference from a first Referencing Object and a second Object Reference from a second Referencing Object to said Shared Referenced Object, said method further comprising:
identifying said Shared Referenced Object and said corresponding first Referencing Object and said second Referencing Object; and
placing said Shared Referenced Object in said Streamable Signal Sequence prior to either of said first Referencing Object and said second Referencing Object to form said Streamable Signal Sequence.

3. A method in accordance with claim 2, said method further comprising:
generating Last Reference Summary Information about said Shared Referenced Object identifying the last of said first Referencing Object and said second Referencing Object in said Streamable Signal Sequence as corresponding to the last Referencing Object Signal containing an Object Reference to said Referenced Object; and
inserting said Last Reference Summary Information into said Streamable Signal Sequence.

4. A method in accordance with claim 1, wherein said Referenced Object is a non-shared Referenced Object, said method further comprising:
generating Last Reference Summary Information about said Referenced Object identifying said Referencing Object in the Streamable Signal Sequence as corresponding to the last Referencing Object Signal containing an Object Reference to said Referenced Object; and
inserting said Last Reference Summary Information into said Streamable Signal Sequence.

5. A method in accordance with claim 1, wherein said Referenced Object is a non-shared Referenced Object from a corresponding Referencing Object, where said Referencing Object has an Object Reference from said Referencing Object to said Referenced Object, said method further comprising:
said step of determining said network of references between said plurality of Objects, further includes the step of identifying the size of the portion of said Referencing Object following said Object Reference to said non-shared Referenced Object; and
placing said Referenced Object in said Streamable Signal Sequence prior to said corresponding Referencing Object if said Referenced Object is smaller than said portion of said Referencing Object following said Object Reference to said non-shared Referenced Object, and placing said Referenced Object in said Streamable Signal Sequence after its corresponding Referencing Object if said Referenced Object is larger than said portion of said Referencing Object following said Object Reference to said non-shared Referenced Object, to form said Streamable Signal Sequence.

6. A method in accordance with claim 1, further comprising:
generating Memory Requirement Summary Information regarding the amount of memory required to process said Streamable Signal Sequence; and
inserting said Memory Requirement Summary Information into said Streamable Signal.

7. A method in accordance with claim 1, further comprising:
generating identification Summary Information to identify said Streamable Signal Sequence; and
inserting said identification Requirement Summary Information into said Streamable Signal.

8. A method in accordance with claim 1, further comprising:
generating non-shared Summary Information to indicate that all Objects in said Streamable Signal Sequence are non-shared; and
inserting said non-shared Summary Information into said Streamable Signal.

9. A method in accordance with claim 1, wherein said Arbitrary Order Signal Sequence is a Portable Document Format (PDF) file, said method further comprising:
generating identification Summary Information to identify said Streamable Signal Sequence as a streamable PDF file; and
inserting said identification Summary Information into said Streamable Signal.

10. A method in accordance with claim 9, wherein each of said Objects are PDF objects, and said each of said Object References is a PDF object is a PDF Object Identifier.

11. A method in accordance with claim 1, further comprising
generating Summary Information regarding at least one of said Referenced Object and said Referencing Object, wherein said Summary Information is a PDF xref table; and
inserting said Summary Information into said Streamable Signal Sequence.

12. A method for processing an Arbitrary Order Signal Sequence having a plurality of Objects and a plurality of Object References between said plurality of Objects, said method transforming said Arbitrary Order Signal Sequence into a Streamable Signal Sequence, said method comprising:
determining a network of references between said plurality of Objects, said step of determining including identifying at least one Referenced Object and a corresponding Referencing Object containing an Object Reference to said Referenced Object;
splitting said Referencing Object into a first Referencing Object and a second Referencing Object such that the Object Reference to said Referenced Object is at the end of said first Referencing Object; and
placing said Referenced Object between said first Referencing Object and said second Referencing Object created by said step of splitting said Referencing Object in said Streamable Signal Sequence.

13. A method for processing an Arbitrary Order Signal Sequence having a plurality of Objects and a plurality of Object References between said plurality of Objects, said method transforming said Arbitrary Order Signal Sequence into a Streamable Signal Sequence, said method comprising:
determining a network of references between said plurality of Objects, said step of determining including identifying at least one Referenced Object that is referenced by a first Referencing Object and a second Referencing Object, each of said first and second Referencing Objects containing an Object Reference to said Referenced Object;
replicating said Referenced Object into a first replicated Referenced Object and a second Referenced Object;
placing said first replicated Referenced Object in said Streamable Signal Sequence prior to said first Referencing Object in said Streamable Signal Sequence; and
placing said second replicated Referenced Object in said Streamable Signal Sequence prior to said second Referencing Object in said Streamable Signal Sequence.

14. A method for processing an Arbitrary Order Signal Sequence having a plurality of Objects and a plurality of Object References between said plurality of Objects, said method transforming said Arbitrary Order Signal Sequence into a Streamable Signal Sequence, said method comprising:
determining a network of references between said plurality of Objects, said step of determining including identifying at least one Referenced Object and a corresponding Referencing Object containing an Object Reference to said Referenced Object;
placing said Referenced Object in said Streamable Signal Sequence prior to said corresponding Referencing Object, responsive to said determining step, to form said Streamable Signal Sequence;
said step of determining a network of references between said plurality of Objects including identifying at least one shared Referenced Object that is referenced by a first Referencing Object and a second Referencing Object, each of said first and second Referencing Objects containing an Object Reference to said shared Referenced Object;
replicating said shared Referenced Object into a first replicated Referenced Object and a second replicated Referenced Object;
placing said first replicated Referenced Object in said Streamable Signal Sequence prior to said first Referencing Object in said Streamable Signal Sequence;
placing said second replicated Referenced Object in said Streamable Signal Sequence prior to said second Referencing Object in said Streamable Signal Sequence;
generating Summary Information regarding at least one of said Referenced Object, said Referencing Object, said shared Referenced Object, said first Referencing Object, said second Referencing Object, said first replicated Referenced Object and said second replicated Referenced Object; and
inserting said Summary Information into said Streamable Signal Sequence.

15. A method in accordance with claim 14, further comprising:
said step of determining a network of references between said plurality of Objects including identifying at least one non-shared Referenced Object and a corresponding third Referencing Object containing an Object Reference to said non-shared Referenced Object;
splitting said third Referencing Object into a fourth Referencing Object and a fifth Referencing Object such that the Object Reference to said non-shared Referenced Object is at the end of said third Referencing Object; and
placing said non-shared Referenced Object between said fourth Referencing Object and said fifth Referencing Object created by said step of splitting said third Referencing Object in said Streamable Signal Sequence.

16. A method in accordance with claim 15, said method further comprising:
generating Last Reference Summary Information about said Shared Referenced Object identifying the last of said first Referencing Object and said second Referencing Object in said Streamable Signal Sequence as corresponding to the last Referencing Object Signal containing an Object Reference to said Referenced Object; and
inserting said Last Reference Summary Information into said Streamable Signal Sequence.

17. A method in accordance with claim 14, wherein said Referenced Object is a non-shared Referenced Object, said method further comprising:
generating Last Reference Summary Information about said Referenced Object identifying said Referencing Object in the Streamable Signal Sequence as corresponding to the last Referencing Object Signal containing an Object Reference to said Referenced Object; and
inserting said Last Reference Summary Information into said Streamable Signal Sequence.

18. A method in accordance with claim 14, wherein said Referenced Object is a non-shared Referenced Object from a corresponding Referencing Object, where said Referencing Object has an Object Reference from said Referencing Object to said Referenced Object, said method further comprising:
said step of determining said network of references between said plurality of Objects, further includes the step of identifying the size of the portion of said Referencing Object following said Object Reference to said non-shared Referenced Object; and
placing said Referenced Object in said Streamable Signal Sequence prior to said corresponding Referencing Object if said Referenced Object is smaller than said portion of said Referencing Object following said Object Reference to said non-shared Referenced Object, and placing said Referenced Object in said Streamable Signal Sequence after its corresponding Referencing Object if said Referenced Object is larger than said portion of said Referencing Object following said Object Reference to said non-shared Referenced Object, to form said Streamable Signal Sequence.

19. A method in accordance with claim 14, further comprising:
generating Memory Requirement Summary Information regarding the amount of memory required to process said Streamable Signal Sequence; and
inserting said Memory Requirement Summary Information into said Streamable Signal.

20. A method in accordance with claim 14, further comprising:
generating identification Summary Information to identify said Streamable Signal Sequence; and
inserting said identification Summary Information into said Streamable Signal.

21. A method in accordance with claim 14, further comprising:
generating non-shared Summary Information to indicate that all Objects in said Streamable Signal Sequence are non-shared; and
inserting said non-shared Summary Information into said Streamable Signal.

22. A method in accordance with claim 14, wherein said Arbitrary Order Signal Sequence is a PDF file, said method further comprising:
generating identification Summary Information to identify said Streamable Signal Sequence as a streamable PDF file; and
inserting said identification Summary Information into said Streamable Signal.

23. A method in accordance with claim 14, wherein each of said Objects are PDF objects, and said each of said Object References is a PDF object is a PDF Object Identifier.

24. A method in accordance with claim 14, wherein said Summary Information includes a PDF xref table.

25. A method for processing a Streamable Signal Sequence having a plurality of Objects and a plurality of Object References between said plurality of Objects and including at least one non-shared Referenced Object and a corresponding Referencing Object containing an Object Reference to said non-shared Referenced Object, said Streamable Signal Sequence further having said non-shared Referenced Object in said Streamable Signal Sequence placed prior to said corresponding Referencing Object, said Streamable Signal Sequence further including Last Reference Summary Information about said non-shared Referenced Object identifying said Referencing Object in the Streamable Signal Sequence as corresponding to the last Referencing Object Signal containing an Object Reference to said non-shared Referenced Object, said method comprising:
receiving said non-shared Referenced Object and said Last Reference Summary Information;
storing said non-shared Referenced Object in a memory;
processing said Referencing Object containing said Object Reference to said non-shared Referenced Object; and
deleting, responsive to Last Reference Summary Information, said non-shared Referenced Object from said memory.

26. A method for processing a Streamable Signal Sequence having a plurality of Objects and a plurality of Object References between said plurality of Objects and including at least one shared Referenced Object having a first Object Reference from a first Referencing Object and a second Object Reference from a second Referencing Object to said Shared Referenced Object, said Streamable Signal Sequence further having said Shared Referenced Object placed prior to either of said first Referencing Object and said second Referencing Object, said Streamable Signal Sequence further comprising Last Reference Summary Information about said Shared Referenced Object identifying the last of said first Referencing Object and said second Referencing Object in said Streamable Signal Sequence as corresponding to the last Referencing Object Signal containing an Object Reference to said Shared Referenced Object; said method comprising:
receiving said Shared Referenced Object and said Last Reference Summary Information;
storing said Shared Referenced Object in a memory;
processing said first Referencing Object containing said Object Reference to said Shared Referenced Object;
processing said second Referencing Object containing said Object Reference to said Shared Referenced Object; and
deleting, responsive to Last Reference Summary Information, said Shared Referenced Object from said memory.
